(19) United States
(12) Patent Application Publication
(10) Pub. No.: US 2010/0069098 A1
(43) Pub. Date: Mar. 18, 2010

(54) Femtocell access control list addition confirmation

(76) Inventors: Sanjeev Mahajan, Naperville, IL (US); Sarvar Patel, Montville, NJ (US)

Correspondence Address: Carmen Patti Law Group, LLC, One N. LaSalle Street, 44th Floor, Chicago, IL, 60602, US

(21) Appl. No.: 12/215,810

(22) Filed: Jun. 30, 2008

(51) Int. Cl. H04W 4/12; H04W 4/00

(52) U.S. Cl. 455/466; 455/434

(57) ABSTRACT

An apparatus in one example has: a femtocell operatively coupled to an operations support system and operatively coupleable to a mobile terminal; a femtocell access control list operatively coupled to the operations support system and the femtocell; and an SMS control center operatively coupled to the operations support system and to the femtocell; wherein an addition of the mobile terminal to the femtocell access control list is initiated; wherein a message is sent to the mobile terminal that informs the mobile terminal that the mobile terminal is being added to the femtocell; wherein a response is communicated from the mobile terminal to the operations support system; and wherein the mobile terminal is added to the access control list upon receipt of the response. Thus, the present method and apparatus control addition of mobile terminals to access control lists for femtocells.

### TECHNICAL FIELD

The invention relates generally to telecommunication systems, and in particular to controlling addition of mobile terminals to access control lists in femtocells.

### BACKGROUND

In telecommunications, a femtocell, originally known as an access point base station, is a small cellular base station, typically designed for use in residential or small business environments. It connects to the service provider's network via broadband (such as DSL or cable); current designs typically support 2 to 5 mobile phones in a residential setting. A femtocell allows service providers to extend service coverage indoors, especially where access would otherwise be limited or unavailable. The femtocell incorporates the functionality of a typical base station but extends it to allow a simpler, self contained deployment.

A femto BSR (base station router) has an access control list (ACL) that controls the subscribers that can access the wireless network via the femto BSR. A subscriber needs to be added to this list prior to gaining access to network. However, there is a security concern that the femtocell owner may add a neighbor to the respective ACL without the owner's knowledge and potentially evesdrop on calls.

Current proposed solutions provide for a button on the femtocell to add users to the ACL. Once this button is pressed then any mobile devices in a fixed area around the femtocell gets added to the ACL. Alternatively, the femtocell owner may go to a web site to add/drop users from the ACL. Any changes made to the ACL on the Web are downloaded to the femtocell. This limits the usage of the femtocell to only those users that the femtocell allows, however, this is not sufficient to protect the user from a bad femtocell that forces user calls to go through the bad femtocell thereby allowing eavesdropping on the calls.

### SUMMARY

One embodiment according to the present method and apparatus is an apparatus that may comprise: a femcell operatively coupled to an operations support system and operatively coupleable to a mobile terminal; a femtocell access control list operatively coupled to the operations support system and the femtocell; and an SMS control center operatively coupled to the operations support system and to the femtocell; wherein an addition of the mobile terminal to the femtocell access control list is initiated; wherein a message is sent to the mobile terminal that informs the mobile terminal that the mobile terminal is being added to the femtocell; wherein a response is communicated from the mobile terminal to the operations support system; and wherein the mobile terminal is added to the access control list upon receipt of the response.

Another embodiment according to the present method and apparatus is an apparatus that may comprise: at least one mobile terminal operatively coupleable to a femtocell; the femtocell operatively coupled to a femto network gateway via at least a femto base station router and a first network; the femto network gateway operatively coupled to a web server via a second network; the web server operatively coupled to a femtocell owner terminal via a third network; and an access control list in a storage operatively coupled to the femtocell owner terminal.

Another embodiment according to the present method and apparatus is a method that may comprise the steps of: initiating an addition of a mobile terminal to a femtocell access control list for a femtocell; sending a message to the mobile terminal that informs the mobile terminal that the mobile terminal is being added to the femtocell access control list; sending a response from the mobile terminal to acknowledge addition of the mobile terminal to the access control list; and adding the mobile terminal to the access control list upon receipt of the response.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts an embodiment according to the present method and apparatus that supports controlling addition of mobile terminals to access control lists in femtocells.

FIG. 2 is a block diagram depicting one embodiment according to the present method and apparatus.

FIG. 3 is a block diagram depicting another embodiment according to the present method and apparatus.

FIG. 4 is a block diagram depicting yet another embodiment according to the present method and apparatus.

FIG. 5 is a flow diagram depicting one embodiment according to the present method and apparatus.

FIG. 6 is a flow diagram depicting another embodiment according to the present method and apparatus.

FIG. 7 is a flow diagram depicting yet another embodiment according to the present method and apparatus.

### DETAILED DESCRIPTION

For a mobile operator, the attractions of a femtocell are improvements to both coverage and capacity, especially indoors. There may also be opportunity for new services and reduced cost. The cellular operator also benefits from the improved capacity and coverage but also can reduce both capital expenditure and operating expense.

Femtocells are an alternative way to deliver the benefits of fixed mobile convergence (FMC). The distinction is that most FMC architectures require a new (dual-mode) handset which works with existing home/enterprise Wi-Fi access points, while a femtocell-based deployment will work with existing handsets but requires installation of a new access point.

According to embodiments of the present method and apparatus when an attempt is made to add a mobile terminal to the Femtocell ACL via a press of the button or via a Web site or other means, an SMS message informing that the mobile terminal is being added to a Femtocell and containing an accept URL will be sent to the mobile in question. Upon receipt of the SMS message, the mobile user may click on the URL in the SMS message to acknowledge the addition to ACL. The URL would identify the mobile terminal being added. Upon receipt of the acknowledgement at a matching URL the operations support system will add the mobile subscriber to the ACL.

In an alterative embodiment of the present method and apparatus, the SMS message sent to the mobile may be acknowledged by a response SMS. To enhance security a large random number may be included in the SMS message sent to the user. The mobile terminal may approve the addition by replying back with an SMS message including the random number. Upon receipt of the reply SMS message the operation support system may match the random number prior to adding the mobile subscriber to the ACL.

Once the SMS message is delivered to the mobile terminal and the mobile terminal user acknowledges the addition by either replying back to the SMS message including the previously communicated random number or by clicking the URL in the SMS message, the OSS may communicate the addition of the mobile terminal to a home network manager (HNM). The HNM updates the ACL in the respective femtocell.

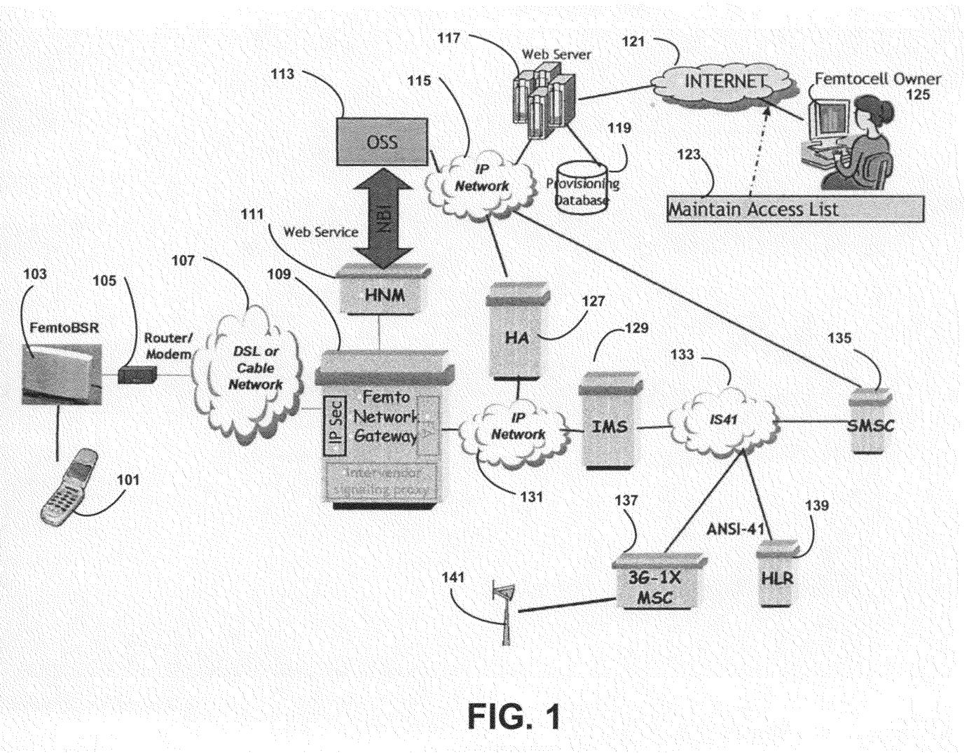

FIG. 1 depicts an embodiment according to the present method and apparatus that supports controlling addition of mobile terminals to access control lists in femtocells. A mobile terminal 101 may communicate with a femtoBSR (femto base station router) 103. The femtoBSR 103 may to operatively coupled to a femto network gateway 109 via a router/modem 105 and DSL or cable network 107. The femto network gateway 109 may be operatively coupled to a HA 127 (home agent) and an IMS 129 (IP multimedia subsystem). The IMS 129 may be operatively coupled to an SMSC 135 (short message service center), an HLR (home location register) 139, and a 3G-1X MSC (mobile switching center) 137. The 3G-1X MSC 137 may be operatively coupled to a base station 141.

The HA 127 and the SMSC 135 may be operatively coupled to an IP network 115 (Internet protocol network). The IP network 115 may also be operatively coupled to the femto network gateway 109 via an OSS 113 (operations support system) and an HNM 111 (home network module). The IP network 115 may also be operatively coupled to a web server 117 that has a provisioning database 119. The web server 117 may be operatively coupled to the Internet 121, which is accessed by a terminal 125 of a femtocell owner and an access control list 123.

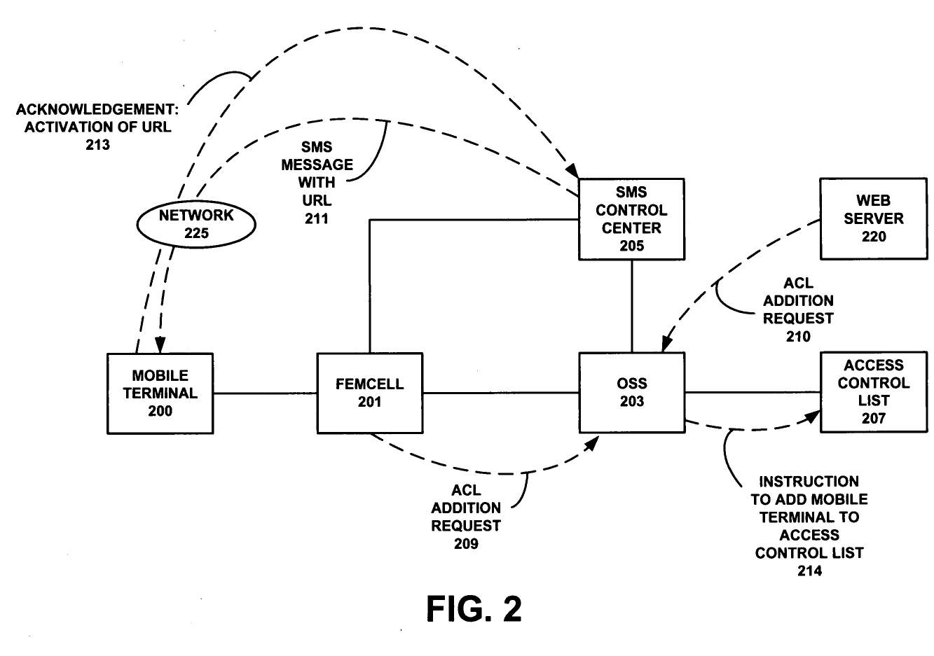

FIG. 2 is a block diagram depicting one embodiment according to the present method and apparatus. In this embodiment an OSS 203 is operatively coupled to a femtocell 201. A femtocell access control list 207 for the femtocell 201 is operatively coupled to the operations support system 203 and the femtocell 201. An SMS control center 205 is operatively coupled to the operations support system 203 and to the femtocell 201.

An addition of the mobile terminal 201 to the femtocell access control list 207 is initiated by sending an ACL addition request 209 from the femtocell 201 or an ACL addition request 209 from the Web Server 220 to the OSS 203. An SMS message with URL 211 is sent from the OSS 203 via an SMS control center 205 to the mobile terminal 200 over macro network 225 that informs the mobile terminal 200 that the mobile terminal 200 is being added to the femtocell ACL. A response is communicated from the mobile terminal 200 to the OSS 203. This includes activating the URL in the SMS message 211 to acknowledge addition of the mobile terminal 200 to the access control list 207. The mobile terminal 200 is added to the access control list 207 upon receipt of the acknowledgement at a matching URL to the accept URL. An instruction 214 to add the mobile terminal 200 to the access control list 207 is sent from the OSS 203 to the access control list 207.

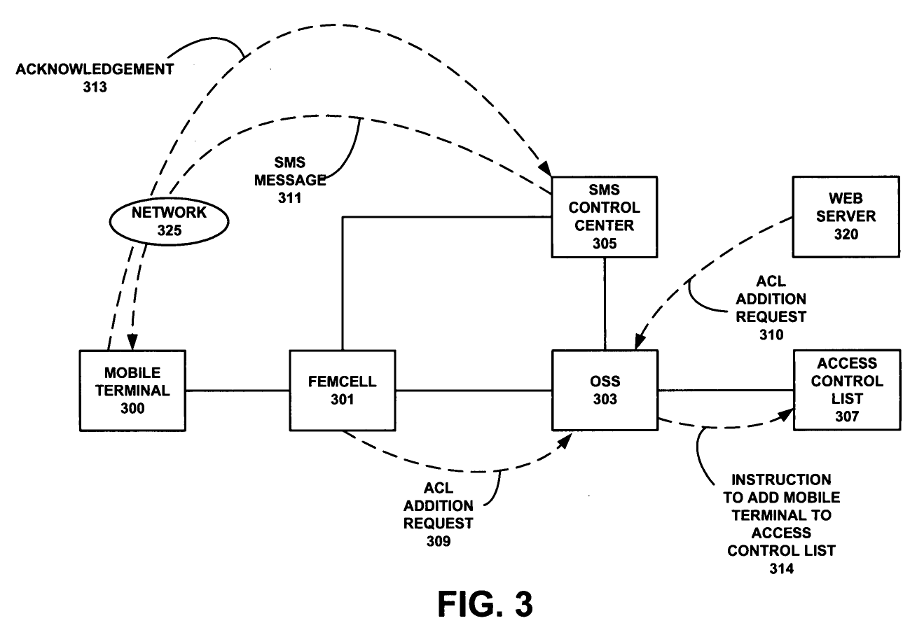

FIG. 3 is a block diagram depicting another embodiment according to the present method and apparatus. In this embodiment an operations support system (OSS) 303 is operatively coupled to a femtocell 301. A femtocell access control list 307 for the femtocell 301 is operatively coupled to the operations support system 303 and the femtocell 301. An SMS control center 305 is operatively coupled to the operations support system 303 and to the femtocell 301.

An addition of the mobile terminal 300 to the femtocell access control list 307 is initiated by sending an ACL addition request 309 from the femtocell 301 or an ACL addition request 310 from the Web Server 320 to the OSS 303. An SMS message 311 is sent from the OSS 303 via an SMS control center 305 to the mobile terminal 300 over the macro network 325 that informs the mobile terminal 300 that the mobile terminal 300 is being added to the femtocell 301 ACL. A response, acknowledgement 313 is communicated from the mobile terminal 300 to the OSS 303 to acknowledge addition of the mobile terminal 300 to the access control list 307. The mobile terminal 300 is added to the access control list 307 upon receipt of the SMS acknowledgement 313. An instruction 315 to add the mobile terminal 300 to the access control list 307 is sent from the OSS 303 to the access control list 307.

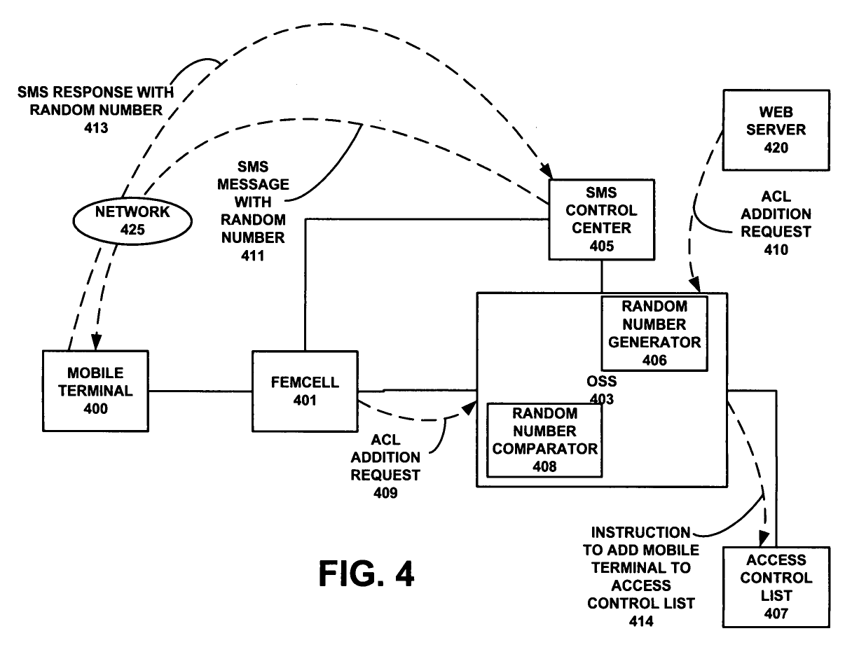

FIG. 4 is a block diagram depicting yet another embodiment according to the present method and apparatus. In this embodiment an operations support system (OSS) 403 is operatively coupled to a femtocell 401. A femtocell access control list 407 for the femtocell 401 is operatively coupled to the operations support system 403 and the femtocell 401. An SMS control center 405 is operatively coupled to the operations support system 403 and to the femtocell 401. In this embodiment the OSS 403 may have a random number generator 406 and a random number comparator 408. The random number generator 406 and a random number comparator 408 may alternatively be located external to the OSS 403.

An addition of the mobile terminal 400 to the femtocell access control list 407 is initiated by sending an ACL addition request 409 from the femtocell 401 or an ACL addition request 410 from the Web Server 420 to the OSS 403. An SMS message with random number 411 is sent from the OSS 403 via an SMS control center 405 to the mobile terminal 400 over the macro network 425 that informs the mobile terminal 400 that the mobile terminal 400 is being added to the ACL 407. An SMS response with random number 413 is communicated from the mobile terminal 400 via the macro network to the OSS 403 to acknowledge addition of the mobile terminal 400 to the access control list 407. The random number received from the mobile terminal 400 may be compared to the random number sent in the SMS message 413. The mobile terminal 400 is added to the access control list 407 upon a matching of the random numbers. An instruction 415 to add the mobile terminal 400 to the access control list 407 is sent from the OSS 403 to the access control list 407.

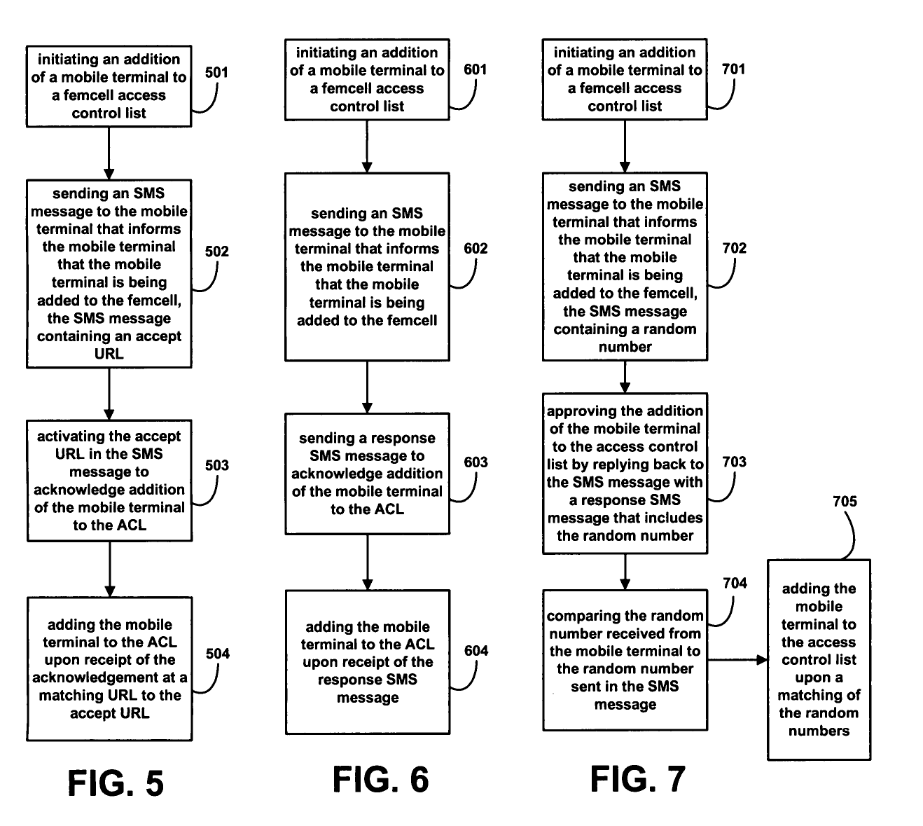

FIG. 5 is a flow diagram depicting one embodiment according to the present method and apparatus. This embodiment according to the present method and apparatus may have the following steps: initiating an addition of a mobile terminal to a femtocell access control list (step 501); sending an SMS message to the mobile terminal that informs the mobile terminal that the mobile terminal is being added to the femtocell, the SMS message containing an accept URL (step 502); activating the accept URL in the SMS message to acknowledge addition of the mobile terminal to the ACL (step 503); and adding the mobile terminal to the ACL upon receipt of the acknowledgement at a matching URL to the accept URL (step 504).

FIG. 6 is a flow diagram depicting another embodiment according to the present method and apparatus. This embodiment according to the present method and apparatus may have the following steps: initiating an addition of a mobile terminal to a femtocell access control list (step 601); sending an SMS message to the mobile terminal that informs the mobile terminal that the mobile terminal is being added to the femtocell (step 602); sending a response SMS message to acknowledge addition of the mobile terminal to the ACL (step 603); and adding the mobile terminal to the ACL upon receipt of the response SMS message (step 604).

FIG. 7 is a flow diagram depicting yet another embodiment according to the present method and apparatus. This embodiment according to the present method and apparatus may have the following steps: initiating an addition of a mobile terminal to a femtocell access control list (step 701); sending an SMS message to the mobile terminal that informs the mobile terminal that the mobile terminal is being added to the femtocell, the SMS message containing a random number (step 702); approving the addition of the mobile terminal to the access control list by replying back to the SMS message with a response SMS message that includes the random number (step 703); comparing the random number received from the mobile terminal to the random number sent in the SMS message (step 704); and adding the mobile terminal to the access control list upon a matching of the random numbers (step 705).

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium for the apparatus in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following.

What is claimed is:

1. An apparatus, comprising:
a femtocell operatively coupled to an operations support system and operatively coupleable to a mobile terminal;
a femtocell access control list operatively coupled to the operations support system and the femtocell; and
an SMS control center operatively coupled to the operations support system and to the femtocell;
wherein an addition of the mobile terminal to the femtocell access control list is initiated; wherein a message is sent to the mobile terminal that informs the mobile terminal that the mobile terminal is being added to the femtocell; wherein a response is communicated from the mobile terminal to the operations support system; and wherein the mobile terminal is added to the access control list upon receipt of the response.

2. The apparatus according to claim 1, wherein each of the message and the response is an SMS message.

3. The apparatus according to claim 1, wherein each SMS message of the message and the response contains a random number.

4. An apparatus, comprising:
at least one mobile terminal operatively coupleable to a femtocell;
the femtocell operatively coupled to a femto network gateway via at least a femto base station router and a first network;
the femto network gateway operatively coupled to a web server via a second network;
the web server operatively coupled to a femtocell owner terminal via a third network; and
an access control list in a storage operatively coupled to the femtocell owner terminal.

5. The apparatus according to claim 4, wherein the first network is one of a DSL and cable network.

6. The apparatus according to claim 4, wherein the second network is an IP network.

7. The apparatus according to claim 4, wherein the third network is the Internet.

8. The apparatus according to claim 4, wherein an addition of the mobile terminal to the femtocell access control list is initiated; wherein a message is sent to the mobile terminal that informs the mobile terminal that the mobile terminal is being added to the femtocell; wherein a response is communicated from the mobile terminal to the femtocell owner terminal; and wherein the mobile terminal is added to the access control list upon receipt of the response.

9. The apparatus according to claim 8, wherein each of the message and the response is an SMS message.

10. The apparatus according to claim 8, wherein the mobile terminal to the femtocell access control list is initiated by sending to the operations support system one of an access control list addition request from the femtocell or an access control list addition request from a Web Server.

11. A method, comprising:
initiating an addition of a mobile terminal to a femtocell access control list for a femtocell;
sending a message to the mobile terminal that informs the mobile terminal that the mobile terminal is being added to the femtocell access control list;
sending a response from the mobile terminal to acknowledge addition of the mobile terminal to the access control list; and
adding the mobile terminal to the access control list upon receipt of the response.

12. The method according to claim 11, wherein the method further comprises:
sending an SMS message to the mobile terminal that informs the mobile terminal that the mobile terminal is being added to the femtocell access control list, the SMS message containing an accept URL;
activating the accept URL in the SMS message to acknowledge addition of the mobile terminal to the access control list; and
adding the mobile terminal to the access control list upon receipt of the acknowledgement at a matching URL to the accept URL.

13. The method according to claim 12, wherein to enhance security the method further comprises:
including a random number in the SMS message;
approving the addition of the mobile terminal to the access control list by replying back to the SMS message with a response SMS message that includes the random number;
comparing the random number received from the mobile terminal to the random number sent in the SMS message; and
adding the mobile terminal to the access control list upon a matching of the random numbers.

14. The method according to claim 13, wherein the accept URL identifies the mobile terminal.

15. The method according to claim 11, wherein the method further comprises:
sending an SMS message to the mobile terminal that informs the mobile terminal that the mobile terminal is being added to the femtocell;
sending a response SMS message to acknowledge addition of the mobile terminal to the ACL; and
adding the mobile terminal to the ACL upon receipt of the response SMS message.

16. The method according to claim 15, wherein to enhance security the method further comprises:
including a random number in the SMS message;
approving the addition of the mobile terminal to the access control list by replying back to the SMS message with a response SMS message that includes the random number;
comparing the random number received from the mobile terminal to the random number sent in the SMS message; and
adding the mobile terminal to the access control list upon a matching of the random numbers.

17. The method according to claim 16, wherein the SMS message identifies the mobile terminal.

18. The method according to claim 16, wherein the random number is a substantially unpredictable random number.

19. The method according to claim 11, wherein the mobile terminal is added to the access control list for the femtocell via a home network manager.

20. The method according to claim 11, wherein each of the message and the response contains an identity of the mobile terminal being added to the access control list.
